(19) United States
(12) Patent Application Publication
(10) Pub. No.: US 2017/0298863 A1
(43) Pub. Date: Oct. 19, 2017

(54) INTERNAL COMBUSTION ENGINE

(71) Applicant: TOYOTA JIDOSHA KABUSHIKI KAISHA, Toyota-shi (JP)

(72) Inventor: Masaki WATANABE, Susono-shi (JP)

(73) Assignee: TOYOTA JIDOSHA KABUSHIKI KAISHA, Toyota-shi (JP)

(21) Appl. No.: 15/432,030

(22) Filed: Feb. 14, 2017

(30) Foreign Application Priority Data
Apr. 14, 2016 (JP) 2016-081370

(51) Int. Cl. F02F 7/00; F02F 1/18

(52) U.S. Cl. CPC F02F 7/0021; F02F 1/18

(57) ABSTRACT

An internal combustion engine including a block movement mechanism comprising a single control shaft extending in parallel with the crankshaft and supported by one of a crankcase and cylinder block and having a main shaft part and eccentric parts with an axial center at a position offset by a predetermined amount from the axial center of the main shaft part, coupling members with one end parts attached to the eccentric parts and the other end parts attached to the other of the crankcase and cylinder block and connecting the control shaft and the other of the crankcase and cylinder block, and an actuator making the control shaft rotate in both directions within a predetermined range of rotation so as to make the axial center of the eccentric parts swing about the axial center of the main shaft part in the direction of relative movement of the cylinder block.

### CROSS-REFERENCE TO RELATED APPLICATION

This application claims priority based on Japanese Patent Application No. 2016-081370 filed with the Japan Patent Office on Apr. 14, 2016, the entire contents of which are incorporated into the present specification by reference.

### TECHNICAL FIELD

The present invention relates to an internal combustion engine.

### BACKGROUND ART

JP2003-206771A discloses, as a conventional internal combustion engine provided with a cylinder block able to move relative to a crankcase, one provided with two eccentric shafts (camshafts) arranged at the two sides of a cylinder block in a short direction and a single drive shaft arranged at one end side of the cylinder block in a long direction so as to make the eccentric shafts rotate in opposite directions to each other and make the cylinder block move relatively.

### SUMMARY

In this way, in a conventional internal combustion engine, in order to make a cylinder block move relatively, eccentric shafts have to be arranged at the two sides of the cylinder block in the short direction and a drive shaft has to be arranged at one end side of the cylinder block in the long direction. For this reason, there is the problem that the internal combustion engine becomes larger in size overall and the weight of the internal combustion engine increases. In particular, the eccentric shafts are provided with pluralities of cam parts and movable bearing parts for their shaft parts, so if two such eccentric shafts are required, the number of parts becomes extremely large. Further, a plurality of bearings through which movable bearing parts are inserted and which support the eccentric shafts to be able to rotate (bearing holding holes) also become necessary. For this reason, the amount of increase of weight of the internal combustion engine also easily becomes larger.

The present invention was made in view of this problem and has as its object to suppress enlargement of an internal combustion engine provided with a cylinder block able to move relative to a crankcase and thereby suppress an increase in weight.

To solve this problem, an internal combustion engine according to one aspect of the prevent invention is provided with a crankcase supporting a crankshaft, a cylinder block able to move relative to the crankcase, and a block movement mechanism for making the cylinder block move relative to the crankcase. Further, the block movement mechanism is provided with a single control shaft extending in parallel with the crankshaft and supported by one of the crankcase and cylinder block and having a main shaft part and eccentric parts with an axial center at a position offset by a predetermined amount from the axial center of the main shaft part, coupling members with one end parts attached to the eccentric parts and with the other end parts attached to the other of the crankcase and cylinder block and connecting the control shaft and the other of the crankcase and cylinder block, and an actuator making the control shaft rotate in both directions within a predetermined range of rotation so as to make the axial center of the eccentric parts swing about the axial center of the main shaft part in the direction of relative movement of the cylinder block.

According to the internal combustion engine according to this aspect of the present invention, by just making a single control shaft extending in parallel to the crankshaft rotate, it is possible to make the cylinder block move relative to the crankcase through the coupling members. For this reason, a single control shaft need only be arranged at just one side of the cylinder block in the short direction. There is no need for providing eccentric shafts at the two sides of the cylinder block in the short direction like in the conventional internal combustion engine explained above. Further, there is no need to place a drive shaft for making the two eccentric shafts rotate at one side of the cylinder block in the long direction. Therefore, it is possible to suppress the enlargement of the internal combustion engine provided with a cylinder block able to move relatively to a crankcase and thereby keep down the increase in weight.

### BRIEF DESCRIPTION OF DRAWINGS

FIG. 1 is a schematic perspective view of an internal combustion engine according to a first embodiment of the present invention.

FIG. 2 is a schematic disassembled perspective view of the internal combustion engine shown in FIG. 1.

FIG. 3 is a schematic disassembled perspective view of the internal combustion engine shown in FIG. 1.

FIG. 4 is a schematic cross-sectional view of an internal combustion engine according to the first embodiment of the present invention.

FIG. 5 is a view explaining the operation of a block movement mechanism.

FIG. 6 is a view explaining the operation of the block movement mechanism and schematically shows the block movement mechanism.

FIG. 7 is a view explaining the problem point in the case of providing a block movement mechanism at only one side of a cylinder block.

FIG. 8 is a view showing by arrows the forces acting on sliders of the internal combustion engine in the first embodiment of the present invention.

FIG. 9 is a view showing by arrows the forces acting on sliders of the internal combustion engine in the second embodiment of the present invention.

### DESCRIPTION OF EMBODIMENTS

Below, embodiments of the present invention will be explained in detail with reference to the drawings. Note that in the following explanation, similar component elements will be assigned the same reference notations.

### First Embodiment

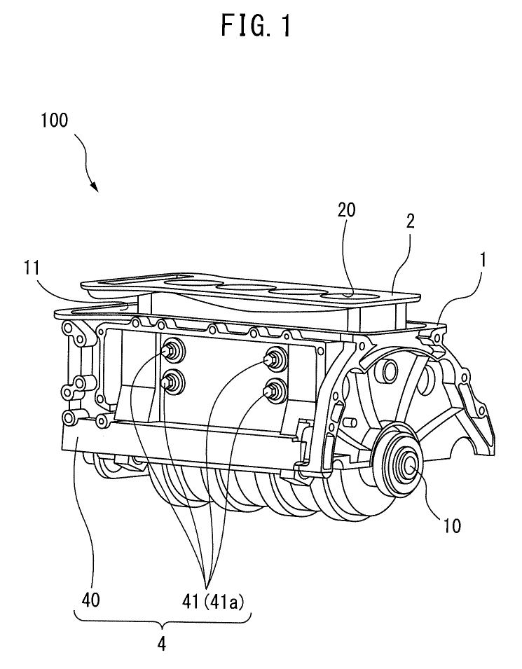

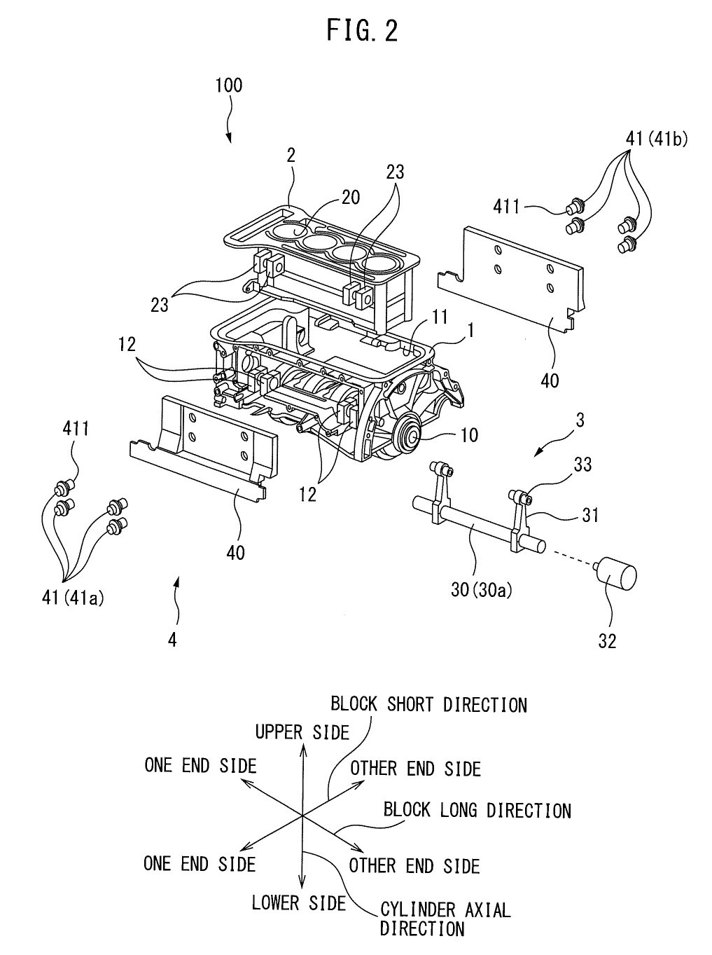

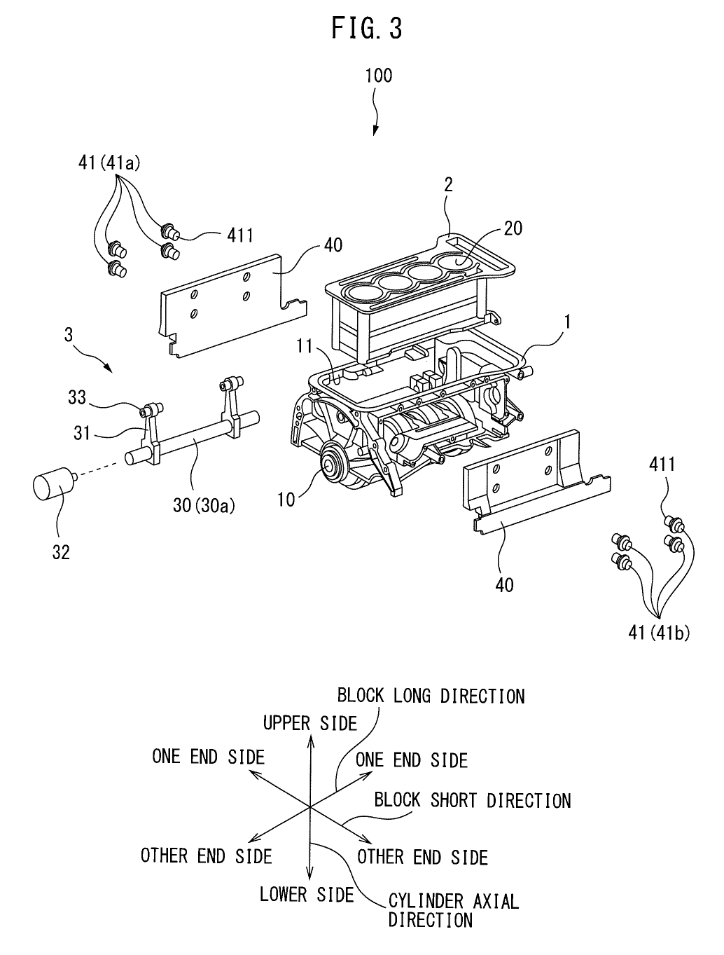

FIG. 1 is a schematic perspective view of an internal combustion engine 100 according to a first embodiment of the present invention. FIG. 2 and FIG. 3 are respectively schematic disassembled perspective views of the internal combustion engine 100 shown in FIG. 1.

As shown from FIG. 1 to FIG. 3, the internal combustion engine 100 is provided with a crankcase 1, cylinder block 2, block movement mechanism 3, and guide mechanism 4.

The crankcase 1 supports a crankshaft 10 to be able to rotate and is provided with a block holding part 11 for holding the cylinder block 2 inside it.

The cylinder block 2 is made a separate member from the crankcase 1 so as to enable relative movement with respect to the crankcase 1. Part of it is held inside the block holding part 11 of the crankcase 1. The cylinder block 2 is formed with cylinders 20. In the present embodiment, four cylinders 20 are formed in series along a long direction of the cylinder block 2 (below, referred to as the “block long direction”).

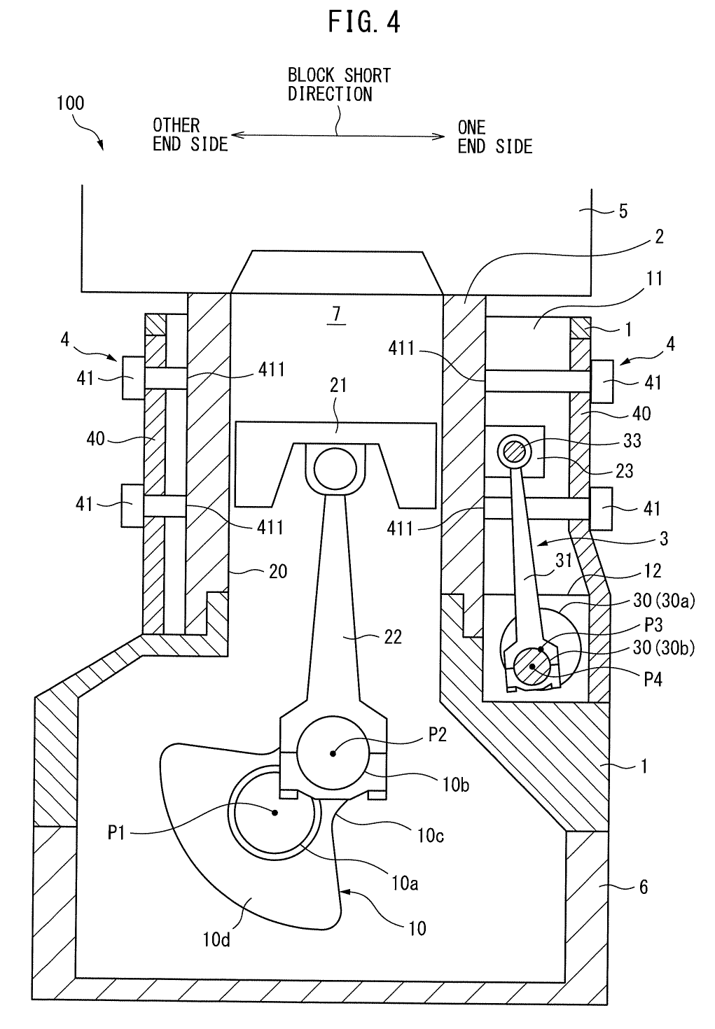

Below, referring to FIG. 4 in addition to FIG. 1 to FIG. 3, the internal configuration of the internal combustion engine 100 and details of the block movement mechanism 3 and guide mechanism 4 will be explained.

FIG. 4 is a schematic cross-sectional view of the internal combustion engine 100. Note that in FIG. 1 to FIG. 3, to prevent complexity in the drawings, part of the components of the internal combustion engine 100 shown in FIG. 4 are omitted.

As shown in FIG. 4, at the top part of the cylinder block 2, a cylinder head 5 is attached, while at the bottom part of the crankcase 1, an oil pan 6 is attached.

Inside each cylinder 20, a piston 21 receiving combustion pressure and moving in a reciprocating manner inside the cylinder 20 is held. The piston 21 is connected through a connecting rod 22 to a crankshaft 10. Due to the crankshaft 10, the reciprocating motion of the pistons 21 is converted to rotary motion. A space defined by the cylinder head 5, a cylinder 20, and a piston 21 forms a combustion chamber 7.

The crankshaft 10 is provided with crank journals 10a, crank pins 10b, and crank arms 10c. The crank journals 10a are parts supported by the crankcase 1 to be able to rotate. The axial center P1 of the crank journals 10a becomes the center of rotation of the crankshaft 10. The crank pins 10b are parts to which the large end parts of the connecting rods 22 are attached. The axial center P2 of the crank pins 10b is offset from the axial center P1 of the crank journals 10a by exactly a predetermined amount. Therefore, if the crankshaft 10 rotates, the axial center P2 of the crank pins 10b rotates about the axial center P1. The crank arms 10c are parts connecting the crank journals 10a and the crank pins 10b. In the present embodiment, to make the crankshaft 10 smoothly rotate, the crank arms 10c are provided with balance weights 10d.

The block movement mechanism 3 is a mechanism for making the cylinder block 2 move relative to the crankcase 1 and, as shown in FIG. 2 to FIG. 4, is provided with a single control shaft 30, coupling members 31, and actuator 32.

The block movement mechanism 3 according to the present embodiment is configured to move the cylinder block 2 in the cylinder axial direction to make the relative position of the cylinder block 2 with respect to the crankcase 1 in the cylinder axial direction change. By making the cylinder block 2 move relative to the crankcase 1 in the cylinder axial direction, it is possible to change only the volumes of the combustion chambers 7 without changing the top dead center positions of the pistons 21. By changing only the volumes of the combustion chambers 7 without changing the top dead center positions of the pistons 21 in this way, it is possible to change the mechanical compression ratio of the internal combustion engine 100. Therefore, the block movement mechanism 3 according to the present embodiment functions as a variable compression ratio mechanism of the internal combustion engine 100. Note that the “mechanical compression ratio” is a compression rate determined mechanically from the stroke volume of a piston 21 and volume of a combustion chamber 7 at the time of a compression stroke and is expressed by (combustion chamber volume+stroke volume)/combustion chamber volume.

The control shaft 30 extends parallel to the crankshaft 10 and is supported by two sets of control bearings 12 (see FIG. 2) provided at the crankcase 1 to be able to rotate and is provided with a main shaft part 30a and eccentric parts 30b with an axial center P4 (see FIG. 4) at a position offset by exactly a predetermined amount from the axial center P3 of the main shaft part 30a (see FIG. 4). Therefore, if making the control shaft 30 rotate once, the axial center P4 of the eccentric parts 30b will rotate once about the axial center P3 of the main shaft part 30a. In the present embodiment, one eccentric part 30b each is provided at one end side and the other end side in the block long direction.

The coupling members 31 are members for connecting the eccentric parts 30b of the control shaft 30 and the cylinder block 2. The coupling members 31 have one end parts at the lower sides in the cylinder axial direction (oil pan 6 side) attached to the eccentric parts 30b of the control shaft 30 and have the other end parts at the upper sides in the cylinder axial direction (cylinder head 5 side) attached to the connecting pins 33 supported by the cylinder block 2. As shown in FIG. 2 and FIG. 3, in the present embodiment, two coupling members 31 connect the eccentric part 30b at one end side in the block long direction with the cylinder block 2 and the eccentric part 30b of the other end side in the block long direction with the cylinder block 2.

Note that in the present embodiment, the control shaft 30 is made a so-called crank shape, but it is also possible to fasten eccentric cams with an axial center offset from the axial center P3 of the main shaft part 30a at the outer circumference of the main shaft part 30a and to attach one end parts of the coupling members 31 to the outer circumferences of the eccentric cams.

As shown in FIG. 2, the connecting pins 33 are supported by support parts 23 provided at the side surface of one end side of the cylinder block 2 in the short direction (direction perpendicularly intersecting block long direction and cylinder axial direction, below, referred to as the “block short direction”). In the present embodiment, one support part 23 each is provided at one end side and the other end side in the block long direction so as to correspond to the eccentric parts 30b.

The actuator 32 is a drive device for giving a drive torque to the control shaft 30 to make the control shaft 30 rotate in two directions within a predetermined range of rotational angle. In the present embodiment, an electric motor is used as the actuator 32.

In this way, the block movement mechanism 3 is configured to be arranged at just one side of the internal combustion engine 100 (in the present embodiment, one end side in the block short direction) to make the cylinder block 2 move relative to the crankcase 1.

The guide mechanism 4 is a mechanism for keeping the cylinder block 2 from tilting in a direction different from the movement direction when making the cylinder block 2 move in a desired movement direction (in the present embodiment, the cylinder axial direction) and is provided with guide walls 40 and sliders 41.

The guide walls 40 are walls provided at the crankcase 1 so as to face side surfaces of the cylinder block 2 and are arranged around the cylinder block 2 at predetermined clearances from the side surfaces of the cylinder block 2.

The sliders 41 are fastened to the guide walls 40 so that the abutting surfaces 411 formed at one ends contact the side surfaces of the cylinder block 2. In the present embodiment, four sliders 41 each are provided at the guide walls 40 facing the two side surfaces of the cylinder block 2 in the block short direction. More specifically, two sliders 41 each are provided at one end side and the other end side of each guide wall 40 in the block long direction at the upper side and lower side in the cylinder axial direction. In this way, in the present embodiment, by using the sliders 41 to support the cylinder block 2 from the two side surfaces, it is possible to keep the cylinder block 2 from tilting in a direction different from the cylinder axial direction when moving the cylinder block 2 in the cylinder axial direction.

Note that, in the following explanation, when differentiation is particularly necessary, the sliders 41 fastened to the guide wall 40 at one end side of the internal combustion engine 100 in the block short direction will be referred to as the “sliders 41a” while the sliders 41 fastened to the guide wall 40 at the other end side of the internal combustion engine 100 in the block short direction will be referred to as the “sliders 41b”.

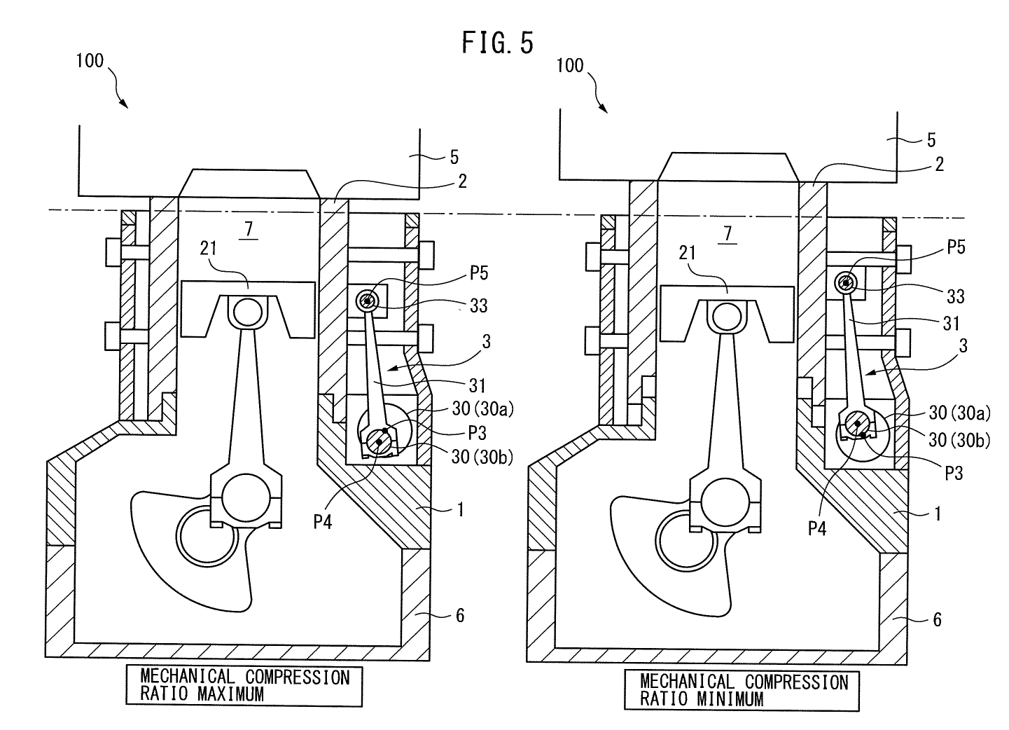

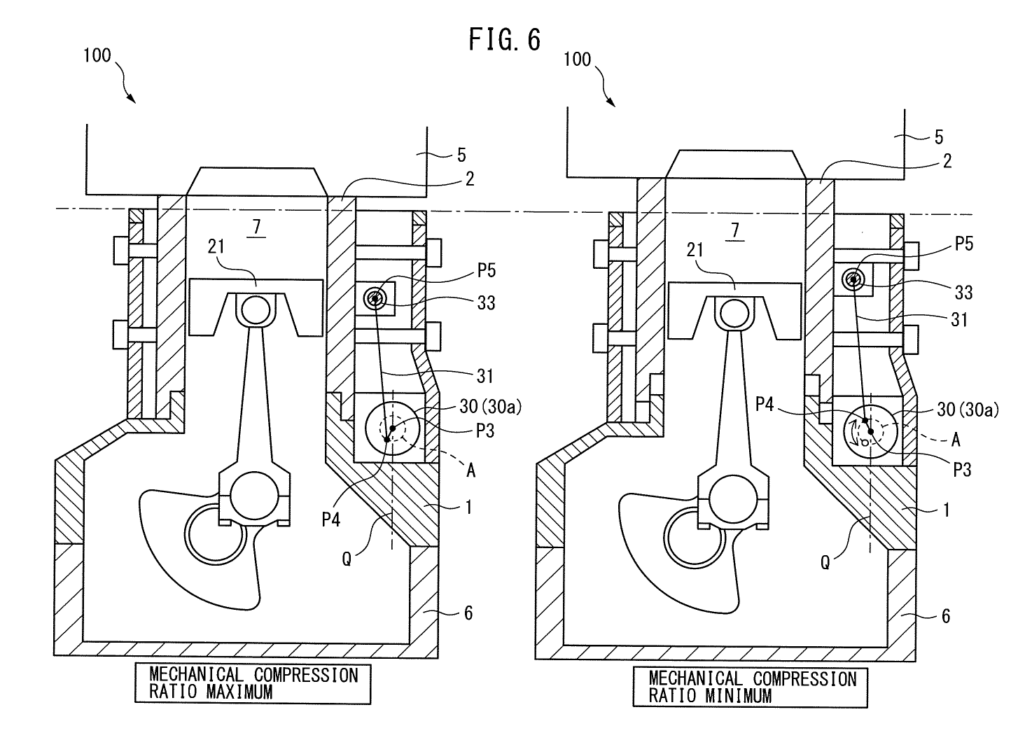

Next, referring to FIG. 5 and FIG. 6, the operation of the block movement mechanism 3 will be explained.

FIG. 5 is a view comparing an internal combustion engine 100 in the state where, due to the block movement mechanism 3, the volumes of the combustion chambers 7 when the pistons 21 are positioned at compression top dead center are made the minimum, that is, the state where the mechanical compression ratio is made maximum, and an internal combustion engine 100 in the state where the control shaft 30 is made to rotate clockwise from that state by exactly a predetermined rotational angle and the volumes of the combustion chambers 7 when the pistons 21 are positioned at compression top dead center are made the maximum, that is, the state where the mechanical compression ratio is made the minimum.

FIG. 6, in the same way as FIG. 5, is a view comparing an internal combustion engine 100 in the state where the mechanical compression ratio is made maximum and an internal combustion engine 100 in the state where the mechanical compression ratio is made minimum, but to facilitate understanding of the invention, the block movement mechanism 3 is schematically shown. Note that in FIG. 6, the broken line A shows the path of the axial center P4 of the eccentric parts 30b when making the control shaft 30 rotate by one turn. Further, P5 is the axial center of the connecting pins 33.

As shown in FIG. 6, in the present embodiment, when dividing the path A of the axial center P4 of the eccentric parts 30b into two semicircular regions by a parallel line Q passing through the axial center P3 of the main shaft part 30a and parallel with the cylinder axial direction, the actuator 32 is used to make the control shaft 30 rotate in the two rotational directions so that the axial center P4 moves in the two rotational directions within the range of either semicircular region (in the present embodiment, the semicircular region at the left side in the figure).

Further, the block movement mechanism 3 is configured so that the axial center P4 of the eccentric parts 30b is positioned at the lower side in the cylinder axial direction (oil pan 6 side) when in the state at the left side in the figure making the mechanical compression ratio maximum compared with the state at the right side in the figure making the mechanical compression ratio minimum.

For this reason, for example, if using the actuator 32 to make the control shaft 30 rotate clockwise from the state at the left side in the figure of the maximum mechanical compression ratio, the axial center P4 of the eccentric parts 30b moves over the path A toward the upper side in the cylinder axial direction (cylinder head 5 side). Due to this, the connecting pins 33 are pushed up straight toward the upper side in the cylinder axial direction through the coupling members 31 connected with the eccentric parts 30b, so the cylinder block 2 is pushed up to the upper side in the cylinder axial direction relative to the crankcase 1. As a result, the volumes of the combustion chambers 7 when the pistons 21 are positioned at top dead center of compression gradually increase and the mechanical compression ratio gradually decreases.

On the other hand, for example, if using the actuator 32 to make the control shaft 30 rotate counterclockwise from the state at the right side in the figure of the minimum mechanical compression ratio, the axial center P4 of the eccentric parts 30b moves over the path A toward the lower side in the cylinder axial direction. Due to this, the connecting pins 33 are pulled down straight toward the lower side in the cylinder axial direction through the coupling members 31 connected with the eccentric parts 30b, so the cylinder block 2 is pulled down to the lower side in the cylinder axial direction relative to the crankcase 1. As a result, the volumes of the combustion chambers 7 when the pistons 21 are positioned at top dead center of compression gradually decrease and the mechanical compression ratio gradually increases.

In this way, the block movement mechanism 3 according to the present embodiment makes a control shaft 30 provided with a main shaft part 30a and eccentric parts 30b rotate so as to make the axial center P4 of the eccentric parts 30b swing about the axial center P3 of the main shaft part 30a up and down in the cylinder axial direction and to make the cylinder block 2 move up and down in the cylinder axial direction by the coupling members 31 connected with the eccentric parts 30b.

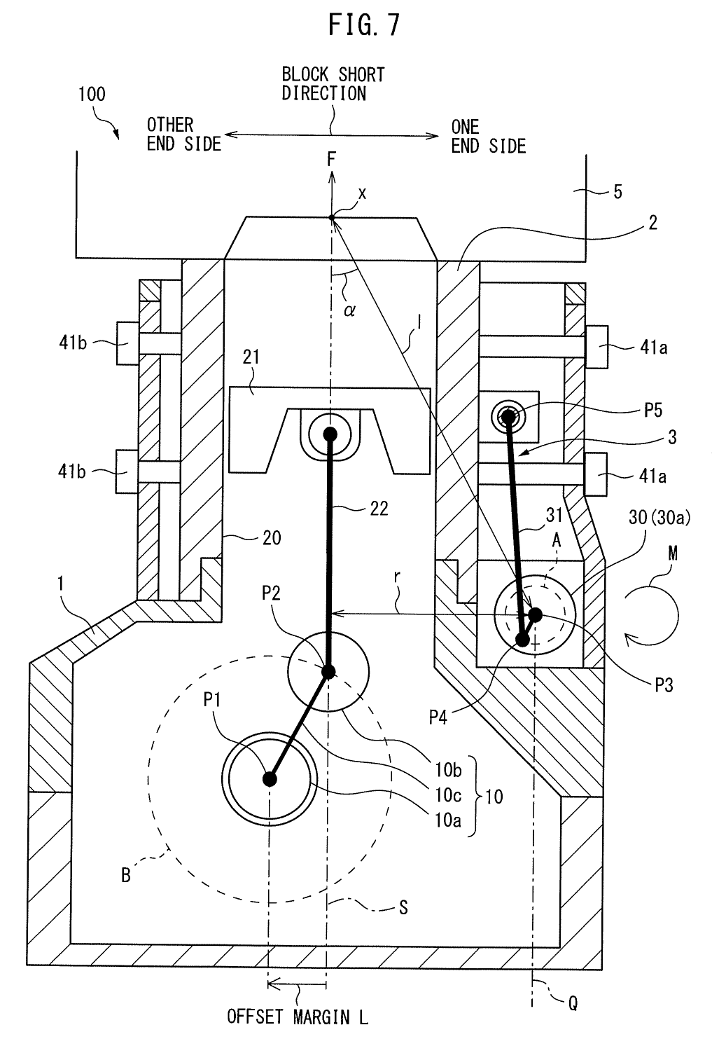

In this regard, in the present embodiment, by providing such a block movement mechanism 3 at only one side of the internal combustion engine 100, enlargement of size and increase of weight of the internal combustion engine 100 are both suppressed. However, when providing the block movement mechanism 3 at only one side in the internal combustion engine 100, compared with when providing block movement mechanisms 3 at the two sides of the internal combustion engine 100, there is the problem that the resistance caused between the abutting surfaces 411 of the sliders 41 and the side surfaces of the cylinder block 2 when making the cylinder block 2 move (below, called the “sliding resistance”) will increase. Below, this problem will be explained with reference to FIG. 7.

FIG. 7 is a view explaining the problem in the case of providing the block movement mechanism 3 at just one side of the internal combustion engine 100 (in this example, one end side in the block short direction). Note that in FIG. 7, to facilitate understanding of the invention, the piston crank mechanism comprised of the pistons 21, connecting rods 22, and crankshaft 10 and the block movement mechanism 3 are shown schematically. Further, in FIG. 7, the broken line B is the path of the axial center P2 of the crank pins 10b when making the crankshaft 10 rotate once.

During operation of the internal combustion engine 100, combustion occurs in the combustion chambers 7 of the cylinders 20, so as shown in FIG. 7, the cylinder head 5 is acted on by an upward combustion load F in the figure. At this time, if, as in the present embodiment, arranging the control shaft 30 along the one side surface of the cylinder block 2 and connecting the control shaft 30 and the cylinder block 2 by the coupling members 31, the combustion load F acting on the cylinder head 5 causes a block rotating force trying to make the cylinder block 2 rotate clockwise in the figure about the control shaft 30. That is, a moment M in the clockwise direction in the figure occurs around the axial center P3 of the main shaft part 30a.

Here, even if providing block movement mechanisms 3 at the two sides of the internal combustion engine 100, for example, at one end side and the other end side in the block short direction, a block rotating force will be generated trying to make the cylinder block 2 rotate clockwise about the control shaft 30 arranged along the side surface of the cylinder block 2 at one end side of the internal combustion engine 100 in the block short direction. Further, conversely to this, a block rotating force will be generated trying to make the cylinder block 2 rotate counterclockwise about the control shaft 30 arranged along the side surface of the cylinder block 2 at the other end side of the internal combustion engine 100 in the block short direction. For this reason, the block rotating force trying to make the cylinder block 2 rotate clockwise and the block rotating force trying to make it rotate counterclockwise become balanced and are cancelled out, so in appearance, no block rotating force is generated at the cylinder block 2.

However, if just providing the block movement mechanism 3 at one side of the internal combustion engine 100, block rotating forces will not cancel each other out like in the case of providing them at the two sides. For this reason, when providing the block movement mechanism 3 at just one side of the internal combustion engine 100, a block rotating force trying to make the cylinder block 2 rotate in a certain rotational direction is constantly generated. This block rotating force acts on the sliders 41 at the side where the block movement mechanism 3 is provided (in the present embodiment, the sliders 41a).

As shown in FIG. 7, when providing the block movement mechanism 3 at only one side of the internal combustion engine 100, the size of the moment M about the axial center P3 caused by the combustion load F is expressed by the following formula (1) where the length of the line segment connecting the axial center P3 and the operating point X of the combustion load F is defined as “1”, the angle formed by that line segment and the operating line of the combustion load F (that is, the cylinder center axis S) is defined as α, and the moment arm is defined as “r”.

M=r×F (1)

where, r=l×sinα

Here, the larger the moment M, the larger the block rotating force. Therefore, the larger the moment M, the larger the force, due to the block rotating force, applied to the sliders 41a abutting against the side surface of the cylinder block 2 at the side where the block movement mechanism 3 is provided. In other words, the larger the moment M, the larger the reaction force which the side surface of the cylinder block 2 at the side where the block movement mechanism 3 is provided receives from the sliders 41a (below, referred to as the “slider reaction force”). Further, the larger the slider reaction force, the greater the sliding resistance when making the cylinder block 2 move in the cylinder axial direction.

In this way, when providing the block movement mechanism 3 at only one side of the internal combustion engine 100, the cylinder block 2 is constantly acted on by a block rotating force in a certain rotational direction, so the sliding resistance when making the cylinder block 2 move in the cylinder axial direction increases.

If the sliding resistance increases, the load when making the cylinder block 2 move in the cylinder axial direction, that is, the drive torque for making the control shaft 30 rotate, increases. For this reason, for example, when making the actuator 32 an electric motor, the power consumption increases and as a result a deterioration of the fuel economy is invited. Further, it is also necessary to raise the maximum drive torque of the actuator 32, so larger size and larger required capacity of the actuator 32 are caused.

Therefore, the sliding resistance is preferably made as small as possible. To make the sliding resistance smaller, the moment M has to be made smaller. As will be understood from formula (1) explained above, the moment M becomes smaller the shorter the moment arm r even if the combustion load F is the same in magnitude. Therefore, to reduce the moment M, it is effective to shorten the moment arm r as much as possible.

Therefore, in the present embodiment, as shown in FIG. 7, the crankcase 1 supports the crankshaft 10 so that the axial center P1 of the crank journals 10a is arranged at a position separated from the cylinder center axis S by exactly a predetermined offset margin L at the other end side of the block short direction. Further, the block movement mechanism 3 was arranged at the one end side of the block short direction forming the opposite side from the direction at which the axial center P1 of the crank journal 10a is separated from the cylinder center axis S by exactly the offset margin L (below, referred to as the “crank offset direction”).

The crankshaft 10 and the control shaft 30 of the block movement mechanism 3 have to be arranged so that the path B of the axial center P2 of the crank pins 10b and the path of the axial center P4 of the eccentric parts 30b do not interfere with each other. For this reason, like in the present embodiment, by arranging the axial center P1 of the crank journals 10a at a position separated from the cylinder center axis S by exactly a predetermined offset margin L at the other end side of the block short direction and by arranging the block movement mechanism 3 at the one end side of the block short direction forming the opposite side to the crank offset direction, it is possible to make the path B of the axial center P2 of the crank pins 10b move in the crank offset direction by exactly the amount of the offset margin L. Therefore, it is possible to create space for arranging the block movement mechanism 3 in the crank offset direction by exactly the amount of the offset margin L and possible to make the path A of the axial center P4 of the eccentric parts 30b move in the crank offset direction by exactly the amount of the offset margin L.

For this reason, compared with the case of arranging the axial center P1 of the crank journals 10a on the cylinder center axis S, it is possible to shorten the moment arm r by exactly the amount of the offset margin L.

Further, when arranging the axial center P1 of the crank journals 10a at a position separated from the cylinder center axis S by exactly a predetermined offset margin L at the other end side of the block short direction, the moment arm r becomes longer by exactly the amount of the offset margin L when arranging the block movement mechanism 3 at the opposite side from the present embodiment, that is, when arranging the block movement mechanism 3 at the other end side of the block short direction forming as the crank offset direction. Therefore, if compared with this, it is possible to shorten the moment arm r by exactly two times the offset margin L.

In this way, by arranging the axial center P1 of the crank journals 10a at a position separated from the cylinder center axis S by exactly a predetermined offset margin L at the other end side of the block short direction and arranging the block movement mechanism 3 at the one end side in the block short direction forming the opposite side to the crank offset direction, it is possible to shorten the moment arm r of the moment M about the axial center P3 caused due to the combustion load F.

Therefore, if providing the block movement mechanism 3 at just one side of the internal combustion engine 100, it is possible to suppress an increase in the sliding resistance when making the cylinder block 2 move in the cylinder axial direction. As a result, it is possible to suppress deterioration of the fuel economy or enlargement of the size and increase of the required capacity of the actuator 32. For this reason, it is possible to further suppress enlargement and increase in weight of the internal combustion engine 100.

The internal combustion engine 100 according to the present embodiment explained above is provided with a crankcase 1 supporting a crankshaft 10, a cylinder block 2 able to move relative to the crankcase 1, and a block movement mechanism 3 for making the cylinder block 2 move relative to the crankcase 1.

Further, the block movement mechanism 3 is provided with a single control shaft 30 extending in parallel with the crankshaft 10 and supported by the crankcase 1 and having a main shaft part 30a and eccentric parts 30b with an axial center P4 at a position offset by a predetermined amount from the axial center P3 of the main shaft part 30a, coupling members 31 with one end parts attached to the eccentric parts 30b and the other end parts attached to the cylinder block 2 and connecting the control shaft 30 and the cylinder block 2, and an actuator 32 for making the control shaft 30 rotate in both directions within a predetermined range of rotation to make the axial center P4 of the eccentric parts 30b swing about the axial center P3 of the main shaft part 30a in the direction of relative movement of the cylinder block 2.

Due to this, according to the present embodiment, by just making one control shaft 30 extending parallel to the crankshaft 10 rotate, it is possible to make the cylinder block 2 move relative to the crankcase 1 through the coupling members 31. For this reason, it is sufficient to arrange a single control shaft 30 at just one side in the short direction of the internal combustion engine 100. There is no need to provide eccentric shafts at both sides of the cylinder block in the short direction like in the above-mentioned conventional internal combustion engine. Further, there is no need to arrange the drive shaft for making the two eccentric shafts rotate at one side in the long direction of the cylinder block. Therefore, it is possible to suppress enlargement of the internal combustion engine 100 provided with a cylinder block 2 able to move relative to a crankcase 1 and thereby suppress an increase in weight.

Further, the eccentric parts 30b of the control shaft 30 and the cylinder block 2 are connected by the coupling members 31, so when making the control shaft 30 rotate, it is possible to change the swinging operation of the eccentric parts 30b about the axial center P3 of the main shaft part 30a efficiently to linear motion parallel to the direction of movement of the cylinder block 2. For this reason, when making the control shaft 30 rotate, it is possible to keep down the force in the block short direction acting on the cylinder block from the coupling members 31.

Further, according to the internal combustion engine 100 according to the present embodiment, the crankcase 1 supports the crankshaft 10 so that the axial center P1 of the crank journals 10a is arranged at a position separated by exactly a predetermined distance (offset margin L) from the center axis S of the cylinder 20 formed at the cylinder block 2. Further, the block movement mechanism 3 is arranged at the opposite side from the direction in which the axial center P1 of the crank journals 10a is separated from the center axis S of the cylinder 20.

Due to this, for example, compared to when arranging the axial center P1 of the crank journals 10a on the center axis S of the cylinder 20, it is possible to shorten the moment arm r of the moment M occurring around the axial center P3 of the main shaft part 30a due to the combustion load F by exactly the amount of the offset margin L. For this reason, when providing the block movement mechanism 3 at only one side of the cylinder block 2, it is possible to reduce the block rotating force in a certain rotational direction acting on the cylinder block 2 due to the combustion load F.

In particular, the internal combustion engine 100 according to the present embodiment is provided with guide walls 40 provided at the crankcase 1 so as to cover the surroundings of the side surfaces of the cylinder block 2 and with sliders 41 respectively attached to the guide wall 40 at the side where the block movement mechanism 3 is arranged and the guide wall 40 at the opposite side to that and abutting against the side surfaces of the cylinder block 2. For this reason, by reducing the block rotating force in a certain rotational direction acting on the cylinder block 2 due to the combustion load F, it is possible to suppress the increase in sliding resistance when making the cylinder block 2 move in the cylinder axial direction in the case when providing the block movement mechanism 3 at only one side of the internal combustion engine 100. Therefore, deterioration of the fuel economy and enlargement or increase of the required capacity of the actuator 32 can be suppressed and in turn enlargement and increase in weight of the internal combustion engine 100 can be further suppressed.

### Second Embodiment

Next, a second embodiment of the present invention will be explained. The present embodiment differs from the first embodiment in the tilt direction of the coupling members 31 of the block movement mechanism 3. Below, this point of difference will be focused on in the explanation.

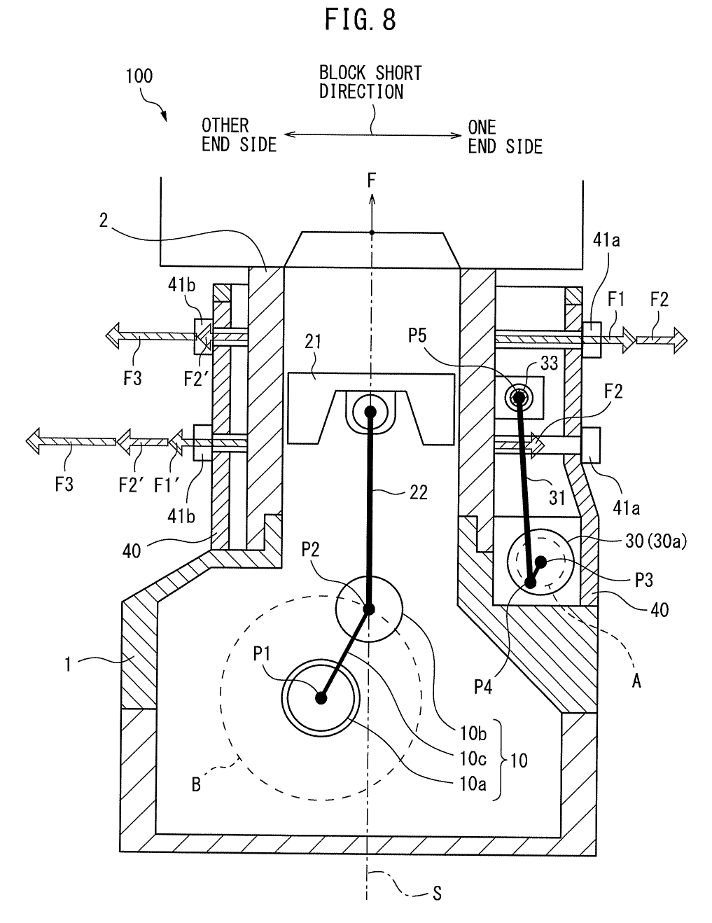

FIG. 8 is a schematic cross-sectional view of an internal combustion engine 100 according to the above-mentioned first embodiment and shows the forces acting on the sliders 41 by arrows. Note that in FIG. 8, the piston crank mechanism comprised of the pistons 21, connecting rods 22, and crankshaft 10 and the block movement mechanism 3 are shown schematically.

As explained above, when providing the block movement mechanism 3 at just one side of the internal combustion engine 100, due to the combustion load F, a block rotating force trying to make the cylinder block 2 rotate in a certain rotational direction is constantly applied to the cylinder block 2.

In the example shown in FIG. 8, a block rotating force trying to make the cylinder block 2 rotate clockwise is applied to the cylinder block 2. For this reason, as shown in FIG. 8, a block rotating force F1 derived from the combustion load F acts on the sliders 41a at the one end side of the block short direction where the block movement mechanism 3 is provided. Further, for the sliders 41b at the other end side in the block short direction, a block rotating force F1′ smaller than the block rotating force F1 acting on the sliders 41a at the one end side of the block short direction acts on only the lower side sliders 41b.

Further, in the example shown in FIG. 8, the crankshaft 10 rotates clockwise, so due to the tilt of the connecting rods 22, during a suction stroke and expansion stroke, a force F2 pushing the cylinder block 2 against one end side in the block short direction (below, referred to as “piston reverse thrust force”) is applied due to the pistons 21. For this reason, as shown in FIG. 8, a piston reverse thrust force F2 acts on the sliders 41a at the one end side in the block short direction at which the block movement mechanism 3 is provided.

On the other hand, during the compression stroke and the exhaust stroke, a force F2′ is applied by which the pistons 21 push the cylinder block 2 to the other end side in the block short direction (below, called “piston forward thrust force”). For this reason, as shown in FIG. 8, a piston forward thrust force F2′ acts on the sliders 41b of the other end side in the block short direction to which the block movement mechanism 3 is provided. The piston reverse thrust force F2 and the piston forward thrust force F2′ are substantially the same in magnitude.

Further, as shown in FIG. 8, in the above-mentioned first embodiment, one end parts of the coupling members 31 were attached to the eccentric parts 30b and the other end parts were attached to the connecting pins 33 so that the axial center P5 of the connecting pins 33 was positioned at the cylinder block 2 side from the axial center P4 of the eccentric parts 30b. That is, the coupling members 31 were tilted so that the other end parts of the coupling members 31 were positioned at the cylinder block 2 side with respect to the one end parts. In the following explanation, for convenience, such tilting of the coupling members 31 so that the other end parts of the coupling members 31 are positioned at the cylinder block 2 side with respect to the one end parts will be referred to as “tilting the coupling member 31 toward the inside of the block”.

When tilting the coupling members 31 toward the inside of the block, the cylinder block 2 is acted on by the force F3 of the coupling members 31 pushing the cylinder block 2 to the other end side in the block short direction (below, called the “first thrust force”). Therefore, this first thrust force F3 acts on the sliders 41b arranged at the other end side in the block short direction.

By tilting the coupling members 31 toward the inside of the block in this way, the composite force acting on the sliders 41 can be dispersed between the sliders 41a arranged at one end side of the cylinder block 2 and the sliders 41b arranged at the other end side. However, in this case, it is necessary to raise the rigidity of both of the guide walls 40 arranged at the two sides of the cylinder block 2. Further, it is also necessary to raise the rigidity of the crankcase 1 at which the guide walls 40 are provided. For this reason, enlargement and increase in weight of the internal combustion engine 100 are liable to be invited.

Therefore, in the present embodiment, the composite force acting on the sliders 41 was made to concentrate at the sliders 41 at one side. Due to this, it is sufficient to raise the rigidity of the guide wall 40 at which the sliders 41 of the side to which the composite force is concentrated are attached, so it is possible to suppress the enlargement and increase in weight of the internal combustion engine 100. Below, the configuration of the internal combustion engine 100 according to the present embodiment will be explained.

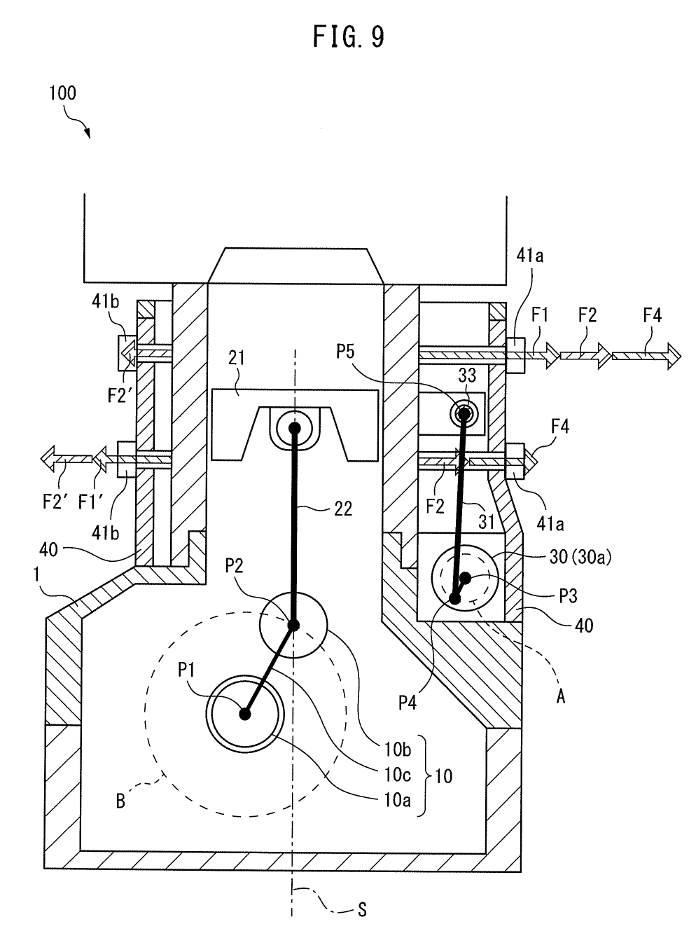

FIG. 9 is a schematic cross-sectional view of an internal combustion engine 100 according to a second embodiment of the present invention. In FIG. 9, to facilitate understanding of the invention, the piston crank mechanism comprised of the pistons 21, connecting rods 22, and crankshaft 10 and the block movement mechanism 3 are shown schematically and the forces acting on the sliders 41 are shown by arrows.

As shown in FIG. 9, in the present embodiment, one end parts of the coupling members 31 are attached to the eccentric parts 30b and the other end parts are attached to the connecting pins 33 so that the axial center P5 of the connecting pins 33 is positioned at the guide wall 40 side from the axial center P4 of the eccentric parts 30b (that is, outside of the internal combustion engine 100). That is, the coupling members 31 are tilted so that the other end parts of the coupling members 31 are positioned at the guide wall 40 side from the one end parts. In the following explanation, for convenience, tilting the coupling members 31 so that the other end parts of the coupling members 31 are positioned at the guide wall 40 side from the one end parts will be referred to as “tilting the coupling member 31 outward from the block”.

When tilting the coupling members 31 outward from the block, the cylinder block 2 is acted on by the coupling members 31 by a force F4 pulling the cylinder block 2 to the guide wall 40 side (below, referred to as “second thrust force”). Therefore, this second thrust force F4 acts on the sliders 41a arranged at one end side in the block short direction.

Due to this, the composite force acting on the sliders 41 can be made to concentrate at the sliders 41a attached to the guide wall 40 at the side where the block movement mechanism 3 is arranged. For this reason, it is sufficient only to raise the rigidity of the guide wall 40 at which the sliders 41a are fastened. Conversely, it is possible to keep low the rigidity of the guide wall 40 at which the sliders 41b are fastened. For this reason, it is possible to suppress the enlargement and increase in weight of the internal combustion engine 100.

According to the internal combustion engine 100 according to the present embodiment explained above, the coupling members 31 are attached at one end parts to the eccentric parts 30b and are attached at the other end parts to the cylinder block 2 so that the other end parts are positioned at the outside of the internal combustion engine 100 from the one end parts.

Due to this, it is possible to tilt the coupling members 31 outward from the block to make the composite force acting on the sliders 41 concentrate at the sliders 41a attached to the guide wall 40 at the side where the block movement mechanism 3 is arranged. For this reason, it is sufficient only to raise the rigidity of the guide wall 40 at which the sliders 41a are fastened. Conversely, it is possible to keep low the rigidity of the guide wall 40 at which the sliders 41b are fastened. For this reason, it is possible to suppress the enlargement and increase in weight of the internal combustion engine 100.

Above, embodiments of the present invention were explained, but the above embodiments only show part of the examples of application of the present invention. The technical scope of the present invention is not limited to the specific configurations of the above embodiments.

For example, in the above embodiments, the control shaft 30 was supported by bearings 12 provided at the crankcase 1 and coupling members were used to connect the control shaft 30 and the cylinder block 2, but conversely from this, for example, it is also possible to support the control shaft 30 by bearings provided at the cylinder block 2 and use the coupling members 31 to connect the control shaft 30 and crankcase 1. That is, the block movement mechanism 3 may also be configured by a single control shaft 30 extending in parallel with the crankshaft 10 and supported by the cylinder block 2, coupling members 31 for connecting the eccentric parts 30b of the control shaft 30 and the crankcase 1, and an actuator 32 for making the control shaft 30 rotate in two directions within a predetermined range of rotation. Even by doing this, effects similar to the above embodiments can be obtained. Further, if configuring the internal combustion engine 100 in this way, it is possible to obtain effects similar to the second embodiment by attaching the other end parts to the eccentric parts 30b and the one end parts to the crankcase 1 so that one end parts of the coupling members 31 are positioned at the outside of the internal combustion engine 100 from the other end parts.

Further, in the above embodiments, two coupling members 31 were used to couple the eccentric parts 30b of the control shaft 30 and the cylinder block 2, but the number of coupling members 31 is not limited to two and may be increased or decreased as needed.

### REFERENCE SIGNS LIST

1. crankcase
2. cylinder block
3. block movement mechanism
10. crankshaft
30. control shaft
30a. main shaft part
30b. eccentric part
31. coupling member
32. actuator
40. guide wall
41. slider
100. internal combustion engine

1. An internal combustion engine comprising:
a crankcase supporting a crankshaft;
a cylinder block able to move relative to the crankcase; and
a block movement mechanism for making the cylinder block move relative to the crankcase,
in which internal combustion engine,
the block movement mechanism comprises:
a single control shaft extending in parallel with the crankshaft and supported by one of the crankcase or the cylinder block and having a main shaft part and eccentric parts with an axial center at a position offset by a predetermined amount from the axial center of the main shaft part;
coupling members with one end parts attached to the eccentric parts and with the other end parts attached to the other of the crankcase or the cylinder block and connecting the control shaft and the other of the crankcase or the cylinder block; and
an actuator for making the control shaft rotate within a predetermined range of rotation in both directions to make axial center of the eccentric parts swing about the axial center of the main shaft part in the relative movement direction of the cylinder block.

2. The internal combustion engine according to claim 1, wherein
the crankcase supports the crankshaft so that the axial center of the crankshaft is arranged at a position separated from the center axis of a cylinder formed in the cylinder block by exactly a predetermined distance and
the block movement mechanism is arranged at the opposite side from the direction in which the axial center of the crankshaft is separated from the center axis of the cylinder.

3. The internal combustion engine according to claim 1, wherein
the control shaft is supported by the crankcase, and
the coupling members are attached at one end parts to the eccentric parts and at the other end parts to the cylinder block so that the other end parts are positioned at the outside of the internal combustion engine from the one end parts.

4. The internal combustion engine according to claim 1, wherein
the control shaft is supported by the cylinder block, and,
the coupling members are attached at the other end parts to the eccentric parts and are attached at the one end parts to the crankcase so that one end parts are positioned at the outside of the internal combustion engine from the other end parts.

5. The internal combustion engine according to claim 1, further comprising:
guide walls provided at the crankcase so as to cover the surroundings of the side surfaces of the cylinder block; and
sliders attached to the guide wall at the side where the block movement mechanism is arranged and the guide wall at the opposite side to that and abutting against the side surfaces of the cylinder block.
